(19) United States
(12) Patent Application Publication
(10) Pub. No.: US 2014/0029678 A1
(43) Pub. Date: Jan. 30, 2014

(54) DATA COMMUNICATIONS OVER COAXIAL CABLE

(71) Applicant: MSD Data Stream, LLC, Perry, UT (US)

(72) Inventors: James Douglas Shuffield, Cedar Park, TX (US); Mark Clyde Rackham, North Ogden, UT (US); Shirlene Pearl Griffin Peck, Brigham City, UT (US)

(73) Assignee: MSD Data Stream, LLC, Perry, UT (US)

(21) Appl. No.: 13/952,128

(22) Filed: Jul. 26, 2013

Related U.S. Application Data
(60) Provisional application No. 61/676,640, filed on Jul. 27, 2012.

(51) Int. Cl. H04B 3/00

(52) U.S. Cl. CPC H04B 3/00
USPC 375/257

(57) ABSTRACT

A system for providing data communications over coaxial cables. The system may include a splitter configured to receive a first signal of a first signal type from a first transmission medium and to split the first signal into a first and second signal parts. The system may also include an adapter coupled to the splitter and configured to receive the first signal part and a second signal of a second signal type that is configured for transmission on a second transmission medium. The adapter may be further configured to combine and to output the first signal part and the second signal on a first cable of the first transmission medium. The system may also include a filter coupled between the splitter and the adapter and configured to prevent the second signal type from reaching the splitter.

### CROSS-REFERENCE TO RELATED APPLICATIONS

This application is based upon and claims the benefit of priority of U.S. Provisional Patent Application No. 61/676,640 filed on Jul. 27, 2012, the entire contents of which are incorporated herein by reference.

### FIELD

The embodiments discussed herein are related to data communications over coaxial cables.

### BACKGROUND

The evolution of Internet Protocol (IP) networking technologies today makes it possible to deliver video (as well as voice and data) over coaxial networks. For example, packet-based data, e.g., Ethernet data, may be map onto a variety of coaxial cables using various modulation technologies or other similar solutions that permit the use of existing coaxial cables to deliver packet-based data throughout a home or building without rewiring.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a system for providing data communications over coaxial cables is disclosed. The system may include a splitter configured to receive a first signal of a first signal type from a first transmission medium and to split the first signal into a first and second signal parts. The system may also include an adapter coupled to the splitter and configured to receive the first signal part and a second signal of a second signal type that is configured for transmission on a second transmission medium. The adapter may be further configured to combine and to output the first signal part and the second signal on a first cable of the first transmission medium. The adapter may maintain a data transfer protocol of the second signal when outputting the second signal on the first cable. The system may also include a filter coupled between the splitter and the adapter and configured to prevent the second signal type from reaching the splitter.

According to an aspect of another embodiment, a method of providing Ethernet over coaxial cables is disclosed. The method includes splitting a first coaxial signal into multiple split coaxial signals using a splitter and receiving multiple Ethernet signals. The method also include outputting one of the Ethernet signals and one of the split coaxial signals onto a coaxial cable while maintaining a data transfer protocol of the one of the Ethernet signals and preventing the one of the Ethernet signals from reaching the splitter.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example data communication system;

FIG. 2A is a block diagram of an example frontend of an Ethernet over coax system;

FIG. 2B is a block diagram of another example frontend of an Ethernet over coax system;

FIG. 3 is a block diagram of another example frontend of an Ethernet over coax system;

FIG. 4 illustrates a multi-dwelling unit with an example Ethernet over coax system; and

FIG. 5 is a flow chart of an example method of providing Ethernet over coaxial cables.

### DESCRIPTION OF EMBODIMENTS

Existing coaxial cables in multi-dwelling units (MDU), such as apartments, condominiums, offices, and other buildings may be used to deliver packetized data, such as IP-packet data. In these situations, the MDU may have a single facility input connection to a network (e.g., the Internet) that may be shared among the dwelling units. To allow the connection to the network to be shared among the dwelling units, the dwelling unit may be coupled in a mesh network. In a mesh network, however, a single device may result in being the gateway to the network connection, thereby splitting the available bandwidth across the number of dwelling units. Splitting the available bandwidth may reduce the bandwidth to any dwelling unit below the level of the maximum bandwidth that may be provided. Furthermore, this scenario also has the drawback of not being an encapsulated system that is easy to setup and easy to administer. The MDU operator would have to administer each individual device instead of having an integral comprehensive management application that coordinates the operation, maintenance, monitoring, and intelligent diagnostics of a system.

To remedy these problems, a system is described herein in at least some embodiments that provides a single point-to-point Ethernet connection between each dwelling unit in a MDU or each data access terminal in a building (referred to herein as a “end user”) and a network gateway over coaxial cable while still supporting television, cable, security, and/or other data feeds over the coaxial cable. The single point-to-point Ethernet connection may assist in providing maximum bandwidth for each end user.

In some embodiments, the system may include a splitter configured to receive a first signal of a first signal type, e.g., a television or cable signal, from a coaxial cable and to split the first signal into a first signal part and a second signal part. The system may then use an adapter coupled to the splitter and configured to combine and to output the first signal part and a full duplex Ethernet signal on a coaxial cable while maintaining a data transfer protocol of the Ethernet signal when outputting Ethernet signal on the coaxial cable. To reduce or prevent collisions of Ethernet signals in the system, a filter may be coupled between the splitter and the adapter and configured to prevent the Ethernet signal from reaching the splitter and thereby maintaining the point-to-point Ethernet connections between each end user and the network gateway.

Furthermore, the system may include a management subsystem operatively coupled together to components of the system that provide the point-to-point Ethernet connections, an extensible network connection to link to additional embodiments to extend the number of units on the network, and a network connection that provides management personnel access to the management subsystem.

The system is further configured to provide minimal operator setup and management and end-user setup on deployment. The system may further include integrated software that may automatically setup, configure, maintain, monitor, and diagnose the system components, which may reduce the need for on-site technical expertise. What is more, the system may be configured to be easily extended for multiple users.

Embodiments of the present invention will be explained with reference to the accompanying drawings.

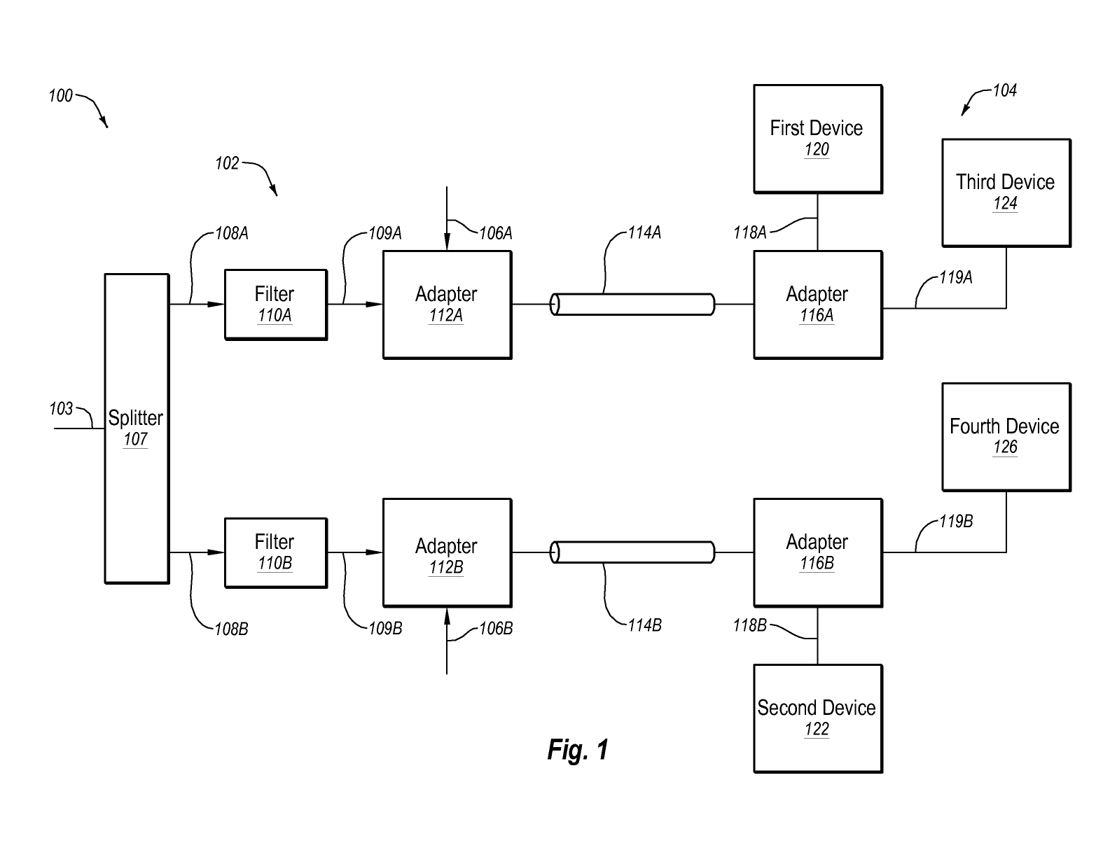

FIG. 1 is a block diagram of an example data communication system 100 (“the system 100”), arranged in accordance with at least one embodiment described herein. The system 100 includes a frontend 102 and a backend 104. The front end 102 includes a splitter 107, first and second filters 110A and 110B (referred to as the “filters 110”), and first and second frontend adapters 112A and 112B (referred to as the “frontend adapters 112”). The back end 104 includes first and second backend adapters 116A and 116B (referred to as the “backend adapters 116”), and first, second, third, and fourth devices 120, 122, 124, and 126.

The splitter 107 is coupled to a first cable 103 of a first communication medium and to second and third cables 108A and 108B of the first communication medium. The splitter 107 may be configured to split a signal of a first signal type on the first cable 103 into a first and second split first signal. The splitter 107 may provide the first and second split signals to the second and third cables 108A and 108B, respectively. In some embodiments, the first communication medium may be a coaxial cable and the first signal type may be a signal such as a television signal, a cable signal, a security signal, or any other signal that may be transmitted along a coaxial cable.

The filters 110 may be coupled between the splitter 107 and the frontend adapters 112. In particular, the first filter 110A may be coupled between the splitter 107 and the first frontend adapter 112A. The first filter 110A may receive the first split first signal from the second cable 108A. The first filter 110A may be configured to pass the first split first signal to the first frontend adapter 112A by way of a fourth cable 109A.

The second filter 110B may be coupled between the splitter 107 and the second frontend adapter 112B. The second filter 110B may receive the second split second signal from the third cable 108B. The second filter 110B may be configured to pass the second split first signal to the second frontend adapter 112B by way of a fifth cable 109B. The fourth and fifth cable 109A and 109B may be of the first communication medium.

The first frontend adapter 112A may receive the first split first signal from the first filter 110A and may receive a second signal of a second signal type from a sixth cable 106A. The second frontend adapter 112B may receive the second split first signal from the second filter 110B and may receive a third signal of the second signal type from a seventh cable 106B.

The sixth and seventh cables 106A and 106B may be of a second communication medium that is different from the first communication medium. Furthermore, the second and third signals may be a different type of signal from the first signal. For example, the sixth and seventh cables 106A and 106B may be Ethernet cables, such as CAT5, CAT5e, CAT6, fiber optic feeds, among other types of cables.

The first frontend adapter 112A may be configured to pass the first split first signal and place the first split first signal onto an eighth cable 114A of the first communication medium. The first frontend adapter 112A may also be configured to modulate the second signal and to place the modulated second signal onto the eighth cable 114A. The first frontend adapter 112A may modulate the second signal in such a manner as to not interfere with the first split first signal. For example, the first split first signal may operate at frequencies below 1 gigahertz (GHz) and the second signal may be modulated at frequencies above 1 GHz so that the first split first signal and the modulated second signal operate at different frequencies.

Thus, the first frontend adapter 112A may be configured to combine the second signal and the first split first signal by outputting the combined second signal and the first split first signal onto the eighth cable 114A. In some embodiments, when modulating the second signal and placing the second signal onto the eighth cable 114A, the first frontend adapter 112A may maintain the data packet structure and/or a data transfer protocol of the second signal.

The second frontend adapter 112B may be configured to pass the second split first signal and place the second split first signal onto a ninth cable 114B of the first communication medium. The second frontend adapter 112B may also be configured to modulate the third signal and to place the modulated third signal onto the ninth cable 114B. The second frontend adapter 112B may modulate the third signal in such a manner as to not interfere with the second split first signal. For example, the second split first signal may operate at frequencies below 1 gigahertz (GHz) and the third signal may be modulated at frequencies above 1 GHz so that the second split first signal and the modulated third signal operate at different frequencies

Thus, the second frontend adapter 112B may be configured to combine the third signal and the second split first signal by outputting the combined third signal and the second split first signal onto the ninth cable 114B. In some embodiments, when modulating the third signal and placing the third signal onto the ninth cable 114B, the second frontend adapter 112B may maintain the data packet structure and/or a data transfer protocol of the third signal.

The eighth and ninth cables 114A and 114B may be of the first communication medium and may be configured to couple the frontend 102 with the backend 104 of the system 100. Furthermore, the eighth cable 114A may be coupled to the first backend adapter 116A and may provide the combined modulated second signal and first split first signal to the first backend adapter 116A. The ninth cable 114B may be coupled to the second backend adapter 116B and may provide the combined modulated third signal and second split first signal to the second backend adapter 116B.

The first backend adapter 116A may be configured to receive the combined modulated second signal and first split first signal. The first backend adapter 116A may provide the first split first signal to a first device 120 by way of a tenth cable 118A. The first backend adapter 116A may also be configured to demodulate the modulated second signal and to provide the demodulated second signal to a third device 124 by way of a eleventh cable 119A.

The second backend adapter 116B may be configured to receive the combined modulated third signal and second split first signal. The second backend adapter 116B may provide the second split first signal to a second device 122 by way of a twelfth cable 118B. The second backend adapter 116B may also be configured to demodulate the modulated third signal and to provide the demodulated third signal to a fourth device 126 by way of a thirteenth cable 119B.

The tenth cable 118A and the twelfth cable 118B may be of the first transmission medium. The first device 120 and the second device 122 may both be configured to use signals of the first signal type. For example, the first signal type may be a cable signal and the first device 120 and the second device 122 may be televisions that display the cable signal.

The eleventh cable 119A and the thirteenth cable 119B may be of the second transmission medium. The third device 124 and the fourth device 126 may both be configured to use signals of the second signal type, such as the second and third signals. For example, the second signal type may be Internet Protocol Television signals (IPTV), VoIP Voice over Internet Protocol signals (VoIP), Video on Demand signals (VOD), High Speed Internet Access signals (HSIA) among other signal types. In these and other embodiments, the third device 124 and the fourth device 126 may be computers, laptops, other some other computing device.

In some embodiments, the third device 124 may provide a fourth signal of the second signal type to the first backend adapter 116A. The first backend adapter 116A may be configured to modulate the fourth signal and to send the modulated fourth signal along the eighth cable 114A to the first frontend adapter 112A. In some embodiments, the first backend adapter 116A may modulate the fourth signal at a frequency that is different that the frequency used to modulate the second signal so that the modulate second and fourth signals may both be transmitted along the eighth cable 114A at the same time with reduced collisions of the modulated second and fourth signals. The first frontend adapter 112A may demodulate the fourth signal and send the fourth signal along the sixth cable 106A to a device that provided the second signal. In this manner, the second signal type may be a fully duplexed signal type.

In some embodiments, the fourth device 126 may provide a fifth signal of the second signal type to the second backend adapter 116B. The second backend adapter 116B may be configured to modulate the fifth signal and to send the modulated fifth signal along the ninth cable 114B to the second frontend adapter 112B. In some embodiments, the second backend adapter 116B may modulate the fifth signal at a frequency that is different that the frequency used to modulate the third signal so that the modulate third and fifth signals may both be transmitted along the ninth cable 114B at the same time with reduced collisions between the modulated third and fifth signals. The second frontend adapter 112B may demodulate the fifth signal and send the fifth signal along the seventh cable 106B to a device that provided the third signal. In this manner, the second signal type may be a fully duplexed signal type.

In some embodiments, the first frontend adapter 112A may not be able to prevent the second or fourth signals from passing to the fourth cable 109A. In order to prevent the second or fourth signals from passing to the splitter 107 and then being transmitted along the third cable 108B and possibly conflicting with the fifth signal or third signals or being transmitted to the fourth device 126, the first filter 110A may be configured to prevent the second or fourth signals from passing to the splitter 107. In a similar manner, the second filter 110B may be configured to prevent the third and fifth signals from passing to the splitter 107.

Note that the first and second filters 110A and 110B preventing a signal of the second signal type from reaching the splitter 107 does not indicate that the first and second filters 110A and 110B completely eliminate the signal from reaching the splitter 107. As is understood in the art, the first and second filters 110A and 110B may attenuate the signal to such a degree as to render the signal with an amplitude equivalent to the amplitude of noise in the system. The signal may thus still exist and reach the splitter 107, but may be indistinguishable from the noise in the system 100 and thus have no effect on the system other than noise in the system 100. In this manner, the first and second filters 110A and 110B may prevent the signal from reaching the splitter 107. For example, in some embodiments, the first and second filters 110A and 110B may filter the signal and thereby attenuate the signal significantly as compared to other signals in the system 100. Alternately or additionally, the first and second filters 110A and 110B may be circulators or other components that are configured to allow signals to pass in a first direction and significantly attenuate signals passing in a second direction.

Using the filters 110, the system 100 may provide point-to-point connections of the second signal type between the sixth cable 106A and the third device 124 and between the seventh cable 106B and the fourth device 126 while providing the first and second split first signals to the first device 120 and the second device 122, respectively.

An example embodiment of the system 100 follows. In this embodiment, the first communication medium is a coaxial cable, the first signal type is a television signal, the second communication medium is an Ethernet cable, and the second signal type is an HSIA signal. The splitter 107 splits the television signal and sends the split television signal to the frontend adapters 112. The first frontend adapter 112A modulates a first HSIA signal and sends the modulated first HSIA signal and the split television signal to the first backend adapter 116A over the coaxial eighth cable 114A. The first backend adapter 116A demodulates the modulated HSIA signal and sends the HSIA signal over the twelfth cable 119A to the third device 124 and the split television signal to the first device 120 over the tenth cable 118A.

Modifications, additions, or omissions may be made to the system 100 without departing from the scope of the present disclosure. For example, the system 100 describes the use of cables, such as cables 108, 109, 114, 118, and/or 119 to couple various components in the system 100. The term cable is used generically and applies to any transmission medium contemplated herein. Furthermore, in some embodiments, various components within the system 100 may be combined. For example, the filters 110 may be combined with the frontend adapters 112. In these and other embodiments, the cables 109 may be internal connections between the filters 110 and the frontend adapter 112 in the combined component. Alternately or additionally, the splitter 107, the filters 110, and the frontend adapters 112 may be combined into a single component.

Furthermore, in some embodiments, the system 100 may include more than two point-to-point connections. In these and other embodiments, the system 100 may include an appropriate number of filters and adapters for the desired number of point-to-point connections.

Additionally, the protocol used to modulate and demodulate the second signal types by the frontend and backend adapters 112 and 116 may be varied without departing from the scope of this disclosure. For example, in some embodiments, the frontend and backend adapters 112 and 116 may use protocols espoused by HPNA, MoCA, among others.

Note that the components of the frontend 102 of the system 100 may be located in near proximity. The components of the backend 104 of the system 100 may be positioned in various locations that are not in near proximity. For example, the first backend adapter 116A, the first device 120, and the third device 124 may be located in a first unit of a MDU and the second backend adapter 116B, the second device 122, and the fourth device 126 may be located in a second unit of a MDU. In these and other embodiments, the first and second units of the MDU may be located in different building or in the same buildings. Alternately or additionally, the different portions of the backend 104 may be positioned in the same unit but be in different rooms within the same unit.

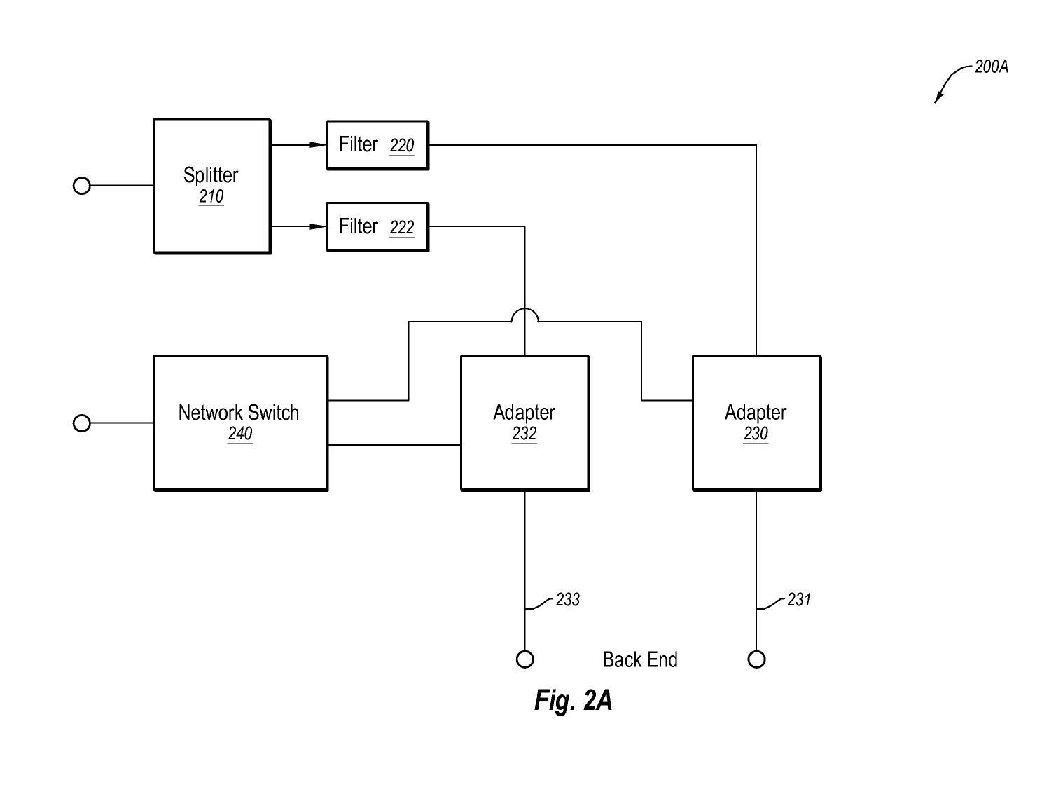

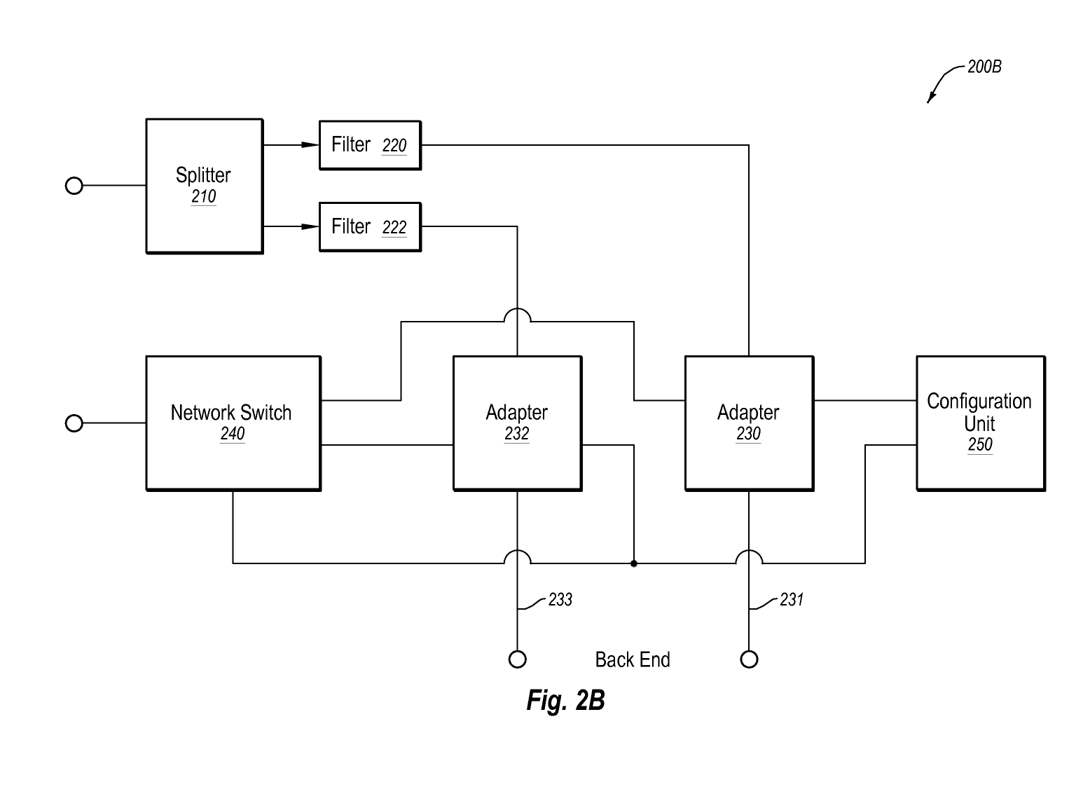

FIG. 2A is a block diagram of an example frontend 200A of an Ethernet over coax system, arranged in accordance with at least one embodiment described herein. The frontend 200A includes a splitter 210, first and second filters 220 and 222, first and second adapters 230 and 232, and a network switch 240.

The splitter 210 may be configured to be coupled to a coaxial cable and to receive a coaxial signal. The splitter 210 may be further configured to split the coaxial signal into first and second coaxial signals and to provide the first and second coaxial signals to the first and second filters 220 and 222, respectively. The first and second filters 220 and 222 may be configured to pass the first and second coaxial signals to the first and second adapters 230 and 232, respectively.

The network switch 240 may be coupled to an Ethernet cable and may be configured to receive an Ethernet signal. Using the received Ethernet signal, the network switch 240 provides first and second Ethernet signals to the first and second adapters 230 and 232, respectively.

The first adapter 230 may be configured to modulate the first Ethernet signal and to add the modulated first Ethernet signal onto a first coaxial cable 231 with the first coaxial signal. The first coaxial cable 231 may be coupled to a backend of the Ethernet over coax system. For example, the first coaxial cable 231 may be coupled to an adapter, which is coupled to a first computing device. In these and other embodiments, a point-to-point Ethernet connection between the network switch 240 and the first computing device may be established.

The second adapter 232 may be configured to modulate the second Ethernet signal and to add the modulated second Ethernet signal onto a second coaxial cable 233 with the second coaxial signal. The second coaxial cable 233 may be coupled to a backend of the Ethernet over coax system. For example, the second coaxial cable 233 may be coupled to a second computing device configured to demodulate the modulated second Ethernet signal. In these and other embodiments, a point-to-point Ethernet connection between the network switch 240 and the second computing device may be established.

The first and second filters 220 and 222 may be configured to prevent the first and second Ethernet signals from reaching the splitter 210 and thus prevents the first and second Ethernet signals from interfering with other point-to-point Ethernet connections established by the network switch 240.

As a result, the frontend 200A may provide Ethernet signals to the first and second adapters 230 and 232. The Ethernet signals may be sent over first and second coaxial cables 231 and 233. In these and other embodiments, the Ethernet signals may be brought out of the backend ready for an Ethernet handoff, such as an internet ready connection. The process may also work in reverse, from the backend to the frontend 200A.

Modifications, additions, or omissions may be made to the frontend 200A without departing from the scope of the present disclosure. For example, one or more of the components of the frontend 200 may be combined together. Alternately or additionally, one or more additional components may be added to the frontend 200A. For example, an amplifier may be added before or after splitting the coaxial signal to amplify the split coaxial signals.

Furthermore, while FIG. 2A illustrates a single splitter, two adapters, two filters, and a single switch, the frontend 200A may be configured with multiple splitters, adapters, filters, and switches depending on the number of desired point-to-point Ethernet connections. For example, the frontend 200A may include 20 point-to-point Ethernet connections. In these and other embodiments, the frontend 200A may include 20 filters, 20 adapters, a single network switch, and a 1:4 way splitter and four 1:6 way splitters configured to split a single coaxial signal into 20 different coaxial signals.

Furthermore, while FIG. 2A illustrates a single frontend, the Ethernet over coax system may include multiple frontends. In these and other embodiments, each of the frontends may have a configuration similar to the frontend 200A. However, in these embodiments, the splitter in one frontend may provide a coaxial signal to another frontend and the network switch in one frontend may provide an Ethernet signal to another front end.

Furthermore, while FIG. 2A illustrates a single Ethernet signal being added to the first and second coaxial cables 231 and 233, multiple Ethernet signals may be added to the first and second coaxial cables 231 and 233 by modulating the different Ethernet signals at different frequencies before placing the different Ethernet signals on the first and second coaxial cables 231 and 233.

FIG. 2B is a block diagram of an example frontend 200B of an Ethernet over coax system, arranged in accordance with at least one embodiment described herein. The frontend 200B may be analogous to the frontend 200A, but may also include the configuration unit 250.

The configuration unit 250 may be coupled to the network switch 240 and the first and second adapters 230 and 232. The configuration unit 250 may be configured to include a comprehensive management application that coordinates the operation, maintenance, monitoring, and intelligent diagnostics of the Ethernet over coax system. For example, the configuration unit 250 may enable or disable the first and second adapters 230 and 232. When enabled, the first and second adapters 230 and 232 may provide the Ethernet signals to the backend of the Ethernet over coax system. When not enabled, the first and second adapters 230 and 232 may not provide the Ethernet signals to the backend of the Ethernet over coax system. Thus, the configuration unit 250 may enable or disable the dissemination of Ethernet signals to specific locations in the backend of the Ethernet over coax system. For example, the second coaxial cable 233 may run to a first unit of a MDU and the first coaxial cable 231 may run to a second unit of a MDU. Thus, by enabling or disabling the first and second adapters 230 and 232 using the configuration unit 250, a user may control whether units within a MDU receive Ethernet signals.

As another example, the configuration unit 250 may be further configured to provide information regarding the network switch 240 and/or the first and second adapters 230 and 232. For example, the configuration unit 250 may provide information regarding the temperature, packets loss, encryption, among other variables associated with the Ethernet signals. In some embodiments, the configuration unit 250 may allow a user to control the frequency at which the first and second adapters 230 and 232 modulate the Ethernet signals onto the first and second coaxial cables 231 and 233.

In some embodiments, the configuration unit 250 may provide remote management capabilities concerning the network switch 240. In these and other embodiments, the network switch may be set-up, monitored, disabled, or otherwise controlled by the configuration unit 250.

In some embodiments, the configuration unit 250 may be accessed over a network and/or remotely. Alternately or additionally, the configuration unit 250 may be accessed using a computer interface device or by manually connecting to the configuration unit 250 using a communications port, such as a USB or Ethernet port. Modifications, additions, or omissions may be made to the frontend 200B without departing from the scope of the present disclosure.

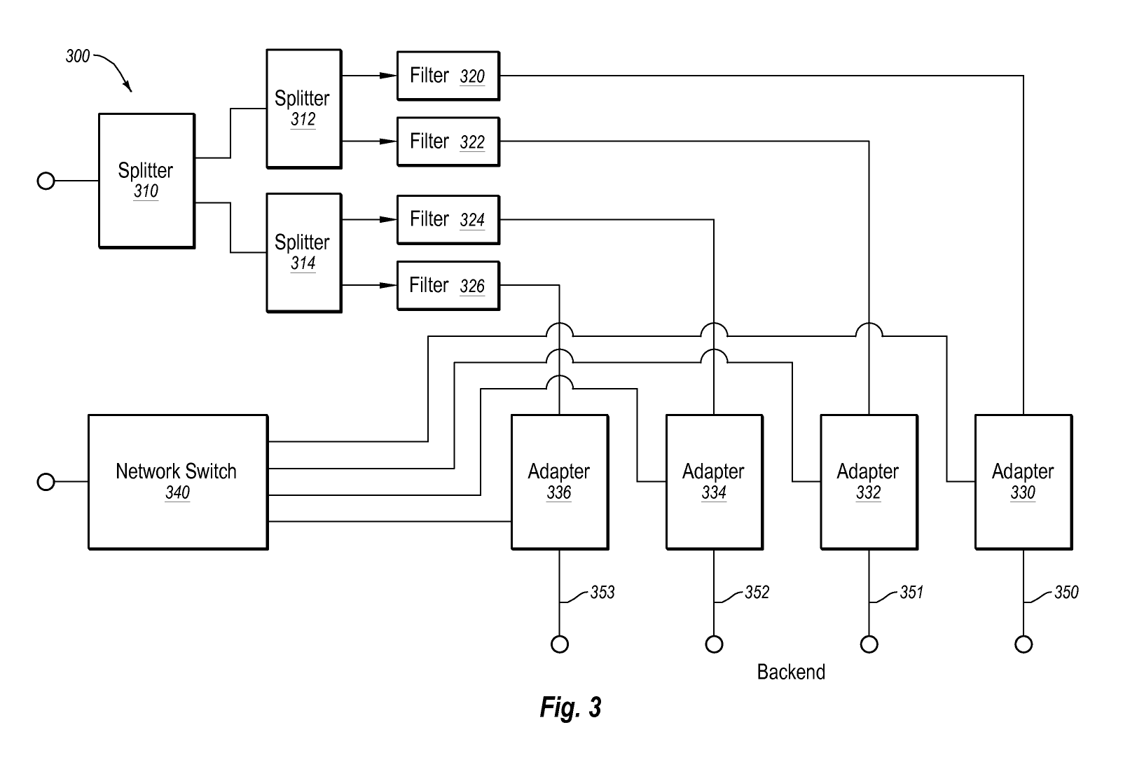

FIG. 3 is a block diagram of another example frontend 300 of an Ethernet over coax system, arranged in accordance with at least one embodiment described herein. The frontend 300 includes first, second, and third splitters 310, 312, and 314; first, second, third, and fourth filters 320, 322, 324, and 326, first, second, third, and fourth adapters 330, 332, 334, and 336, and a network switch 340.

The frontend 300 may be configured to provide four point-to-point connections for Ethernet signals between the backend of the Ethernet over coax system and the network switch 340.

The first, second, and third splitters 310, 312, and 314 may be configured to split a single coaxial signal into four coaxial signals. Each of the four coaxial signals may be passed by one of the first, second, third, and fourth filters 320, 322, 324, and 326 and sent to first, second, third, and fourth adapters 330, 332, 334, and 336.

The network switch 340 may be configured to provide four Ethernet signals for the four point-to-point connections from a received Ethernet signal to the first, second, third, and fourth adapters 330, 332, 334, and 336.

The first, second, third, and fourth adapters 330, 332, 334, and 336 may each be configured to modulate one of the four Ethernet signal from the network switch 340 and to place the modulated Ethernet signals onto one of the coaxial lines 350-353. The first, second, third, and fourth adapters 330, 332, 334, and 336 may also be configured to demodulate Ethernet signals on the coaxial lines 350-353 that are modulated by the backend and pass the demodulate Ethernet signals to the network switch 340 to provide full duplex Ethernet signaling in the Ethernet over coax system that includes the frontend 300.

The first, second, third, and fourth filters 320, 322, 324, and 326 may be configured so that Ethernet signals in the individual point-to-point connections do not migrate to the other point-to-point connections by way of the first, second, and third splitters 310, 312, and 314. Modifications, additions, or omissions may be made to the frontend 300 without departing from the scope of the present disclosure.

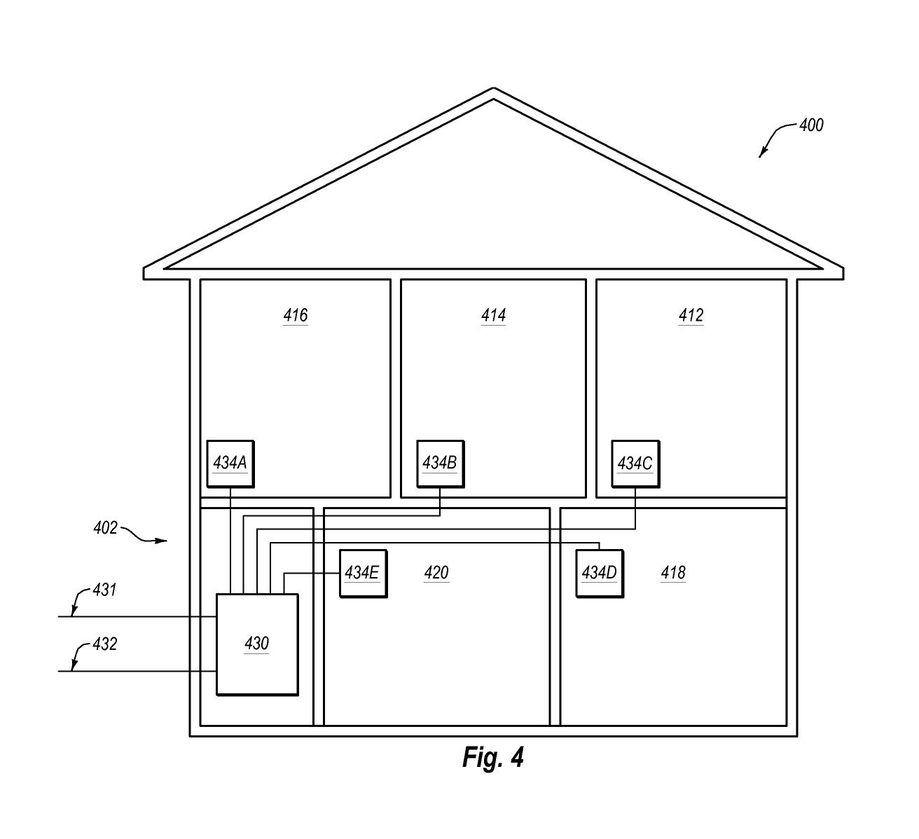

FIG. 4 illustrates a multi-dwelling unit 400 (the “MDU 400”) with an example Ethernet over coax system 402 (“the system 402”), arranged in accordance with at least one embodiment described herein. The MDU 400 includes first, second, third, fourth, and fifth dwellings 412, 414, 416, 418, and 420.

The system 402 includes a frontend 430 and a five point connections 434A, 434B, 434C, 434D, and 434E (referred to as “point connections 434”), which form a backend of the system 402. The five point connections 434 are distributed in the first, second, third, fourth, and fifth dwellings 412, 414, 416, 418, and 420 of the MDU 400. The frontend 430 is configured to receive a coaxial signal over a coaxial cable 431 and an Ethernet signal over an Ethernet cable 432. The frontend 430 is further configured to split the coaxial signal and provide the split coaxial signal to each of the point connections 434. The frontend 430 is further configured to provide a point-to-point Ethernet connection between the frontend 430 and each of the point connections 434.

In some embodiments, the frontend 430 may be a unit that may be installed in the MDU 400. In these and other embodiments, to install the frontend 430, the coaxial cables between the point connections 434 and the coaxial line 431 may be coupled to the frontend 430. Additionally, the Ethernet cable 432 may be coupled to the frontend 430. After some minor configurations and adding adapters at the point connections 434, the frontend 430 may then provide Ethernet over coax to the first, second, third, fourth, and fifth dwellings 412, 414, 416, 418, and 420 in the MDU 400.

Modifications, additions, or omissions may be made to the system 400 without departing from the scope of the present disclosure. For example, in some embodiments, the frontend 430 may be unit that is designed for installation in server racks or for other locations. Furthermore, the Ethernet over coax system may be installed in any type of building. For example, the Ethernet over coax system may be installed in a doctor's office, a hospital, a school, a building, a restaurant, a condo, an apartment, a house, a hotel, a motel, an inn, an office building, a business center, a store, a coffee shop, an amusement park, a mall, a library, a financial institution, an office, a law office, a transportation hub, an airport, a bus station, a train station, a transportation vehicle, a hot spot, or in a home.

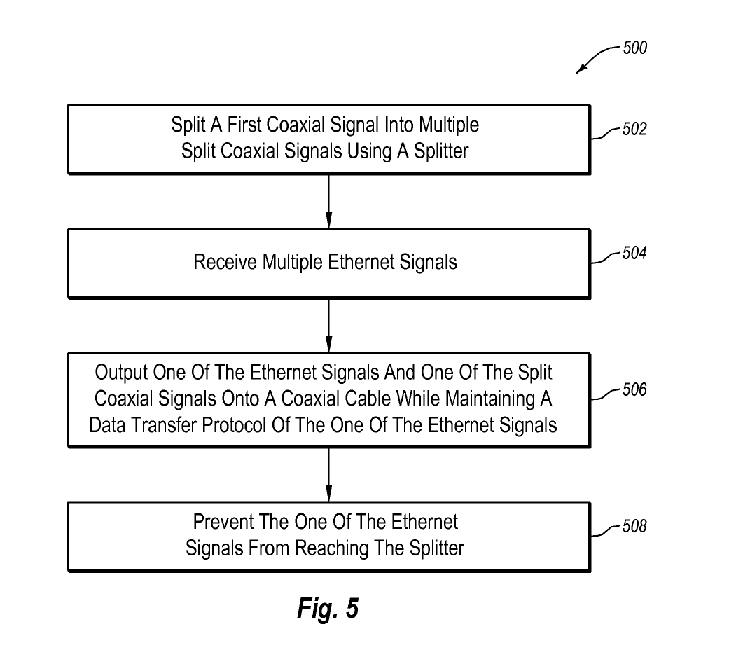

FIG. 5 is a flowchart of an example method 500 of providing Ethernet over coaxial cables, arranged in accordance with at least one embodiment described herein. The method 500 may be implemented, in some embodiments, by an Ethernet over coax system and/or frontend of an Ethernet over coax system, such as the Ethernet over coax systems 100 and 400 of FIGS. 1 and 4, respectively, and/or the frontends 200A, 200B, and 300 of FIGS. 2A, 2B, and 3, respectively. Although illustrated as discrete blocks, various blocks may be divided into additional blocks, combined into fewer blocks, or eliminated, depending on the desired implementation.

The method 500 may begin at block 502, where a first coaxial signal may be split into multiple split coaxial signals using a splitter.

In block 504, multiple Ethernet signals may be received. In some embodiments, the multiple Ethernet signals may be full duplex Ethernet signals. In some embodiments, receiving multiple Ethernet signals may include receiving an Ethernet signal and dividing the Ethernet connection into the multiple Ethernet signals using an Ethernet switch.

In block 506, one of the Ethernet signals and one of the split coaxial signals may be output onto a coaxial cable while maintaining a data transfer protocol of the one of the Ethernet signals.

In block 508, the one of the Ethernet signals may be prevented from reaching the splitter. In some embodiments, the one of the Ethernet signals may be prevented from reaching the splitter by filtering the one of the Ethernet signals.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A system for providing data transfer protocols over coaxial cables, the system comprising:
a splitter configured to receive a first signal of a first signal type from a first transmission medium and to split the first signal into a first signal part and a second signal part;
an adapter coupled to the splitter and configured to receive the first signal part and a second signal of a second signal type that is configured for transmission on a second transmission medium, the adapter further configured to output the first signal part and the second signal on a first cable of the first transmission medium and to maintain a data transfer protocol of the second signal when outputting the second signal on the first cable; and
a filter coupled between the splitter and the adapter and configured to prevent the second signal type from reaching the splitter.

2. The system of claim 1, wherein the filter passes frequencies of the first signal type and attenuates frequencies of the second signal type.

3. The system of claim 1, wherein the first signal comprises of a television signal, a video surveillance signal, or cable signal.

4. The system of claim 1, wherein the first transmission medium comprises a coaxial cable.

5. The system of claim 1, wherein the second signal comprises a full duplex Ethernet signal.

6. The system of claim 1, further comprising a second adapter coupled to the splitter, the second adapter configured to output the second signal part and a third signal of the second signal type on a fourth cable of the first transmission medium.

7. The system of claim 6, further comprising a second filter configured between the splitter and the second adapter.

8. A system for providing data communications over coaxial cables, the system comprising:
a first port configured to receive a first cable of a first transmission medium carrying a first signal of a first signal type;
at least one splitter configured to split the first signal into a plurality of split first signals;
a plurality of adapters, each of the adapters coupled to the splitter and configured to receive a second signal of a second signal type different from the first signal type that is configured for transmission on a second transmission medium, the plurality of adapters further configured to output the second signal and one of the plurality of split first signals on a second cable of the first transmission medium and to maintain a data transfer protocol of the second signal when outputting the second signal on the second cable; and
a plurality of filters coupled between the plurality of adapters and the at least one splitter, the plurality of filters configured to prevent the second signal types from reaching the at least one splitter.

9. The system of claim 8, wherein the filter passes frequencies of the first signal type and attenuates frequencies of the second signal type.

10. The system of claim 8, wherein the first signal type comprises of a television signal, a video surveillance signal, or cable signal.

11. The system of claim 8, wherein the first transmission medium comprises a coaxial cable.

12. The system of claim 8, wherein the second signal type comprises a full duplex Ethernet signal.

13. The system of claim 8, further comprising a network switch configured to provide the second signals to the plurality of adapters.

14. The system of claim 8, further comprising a plurality of splitters, the plurality of splitters configured to generate the plurality of split first signals.

15. The system of claim 8, wherein each filter is integrated with one of the adapters.

16. The system of claim 8, wherein the filters, the splitter, and the adapters are integrated into a single unit.

17. A method of providing Ethernet over coaxial cables, the method comprising:
splitting a first coaxial signal into a plurality of split coaxial signals using a splitter;
receiving a plurality of Ethernet signals;
outputting one of the Ethernet signals and one of the split coaxial signals onto a coaxial cable while maintaining a data transfer protocol of the one of the Ethernet signals; and
preventing the one of the Ethernet signals from reaching the splitter.

18. The method of claim 17, wherein the one of the Ethernet signals is prevented from reaching the splitter by filtering the one of the Ethernet signals.

19. The method of claim 17, wherein receiving the plurality of Ethernet signals includes:
receiving an Ethernet signal; and
dividing the Ethernet signal into the plurality of Ethernet signals using an Ethernet switch.

20. The method of claim 17, wherein the plurality of Ethernet signals are full duplex Ethernet signals.
